(19) United States
(12) Patent Application Publication
(10) Pub. No.: US 2020/0125100 A1
(43) Pub. Date: Apr. 23, 2020

(54) MOVABLE OBJECT CONTROL METHOD, DEVICE AND SYSTEM

(71) Applicant: SZ DJI TECHNOLOGY CO., LTD., Shenzhen (CN)

(72) Inventors: Di WU, Shenzhen (CN); Ketan TANG, Shenzhen (CN)

(21) Appl. No.: 16/719,207

(22) Filed: Dec. 18, 2019

Related U.S. Application Data
(63) Continuation of application No. PCT/CN2017/102081, filed on Sep. 18, 2017.

(51) Int. Cl. G05D 1/00; G06T 7/70; G06K 9/00; G05D 1/08; B64D 47/08; B64C 39/02

(52) U.S. Cl. CPC G05D 1/0094; G06T 7/70; G06K 9/00664; G05D 1/0808; B64C 2201/141; B64C 39/024; G06T 2207/30204; B64C 2201/123; B64C 2201/027; B64D 47/08

(57) ABSTRACT

A terminal device includes one or more processors. The one or more processors are configured to obtain a marker in an image captured by a photographing device, determine position-attitude information of the photographing device relative to the marker, and control the mobile object according to the position-attitude information of the photographing device relative to the marker.

### CROSS-REFERENCE TO RELATED APPLICATION

This application is a continuation of International Application No. PCT/CN2017/102081, filed on Sep. 18, 2017, the entire content of which is incorporated herein by reference.

### TECHNICAL FIELD

The present disclosure generally relates to unmanned aerial vehicle (UAV) technology and, more particularly, to a method for controlling a movable object (mobile object), and an apparatus and system thereof

### BACKGROUND

In conventional technologies, the control method of a UAV includes the remote control, the mobile application (App) control, and the motion sensing control. The motion sensing control refers to that a user holds a handheld device having a build-in Inertial Measurement Unit (IMU) that senses the movement of the user's hand and converts movement information of the user's hand into control commands of the UAV for being sent to the UAV to realize the control of the UAV.

However, the motion sensing control mode can only control the UAV to perform certain fuzzy actions in a large region but cannot precisely control the UAV.

### SUMMARY

In accordance with the disclosure, there is provided a terminal device including one or more processors. The one or more processors are configured to obtain a marker in an image captured by a photographing device, determine position-attitude information of the photographing device relative to the marker, and control the mobile object according to the position-attitude information of the photographing device relative to the marker.

Also in accordance with the disclosure, there is provided a system including an unmanned aerial vehicle (UAV) and a terminal device. The UAV includes a fuselage, a power system provided on the fuselage, an electronic governor communicatively connected to the power system. The power system is configured to provide a power for flight and the electronic governor is configured to control a flight of the UAV. The terminal device includes one or more processors. The one or more processors are configured to obtain a marker in an image captured by a photographing device carried by the UAV, determine position-attitude information of the photographing device relative to the marker, and control the UAV according to the position-attitude information of the photographing device relative to the marker.

### BRIEF DESCRIPTION OF THE DRAWINGS

In order to provide a clearer illustration of technical schemes of disclosed embodiments or conventional technologies, the drawings are briefly described below. It is apparent that the following drawings are merely exemplary. Other drawings may be obtained based on the disclosed drawings by those skilled in the art without creative efforts.

FIG. 1 is a flow chart of a method for controlling a mobile object according to an embodiment of the present disclosure.

FIG. 2 is a schematic diagram of a system for controlling a mobile object according to an embodiment of the present disclosure.

FIG. 3 is a schematic diagram of a user interface of a terminal device according to an embodiment of the present disclosure.

FIG. 4 is a schematic diagram of another user interface of the terminal device according to an embodiment of the present disclosure.

FIG. 5 is a flow chart of a method for controlling a mobile object according to another embodiment of the present disclosure.

FIG. 6 is a flow chart of a method for controlling a mobile object according to another embodiment of the present disclosure.

FIG. 7 is a schematic diagram showing a terminal device moving relative to a user's face according to an embodiment of the present disclosure.

FIG. 8 is another schematic diagram showing the terminal device moving relative to the user's face according to an embodiment of the present disclosure.

FIG. 9 is another schematic diagram showing the terminal device moving relative to the user's face according to an embodiment of the present disclosure.

FIG. 10 is a schematic diagram of another user interface of the terminal device according to an embodiment of the present disclosure.

FIG. 11 is a structural diagram of a terminal device according to an embodiment of the present disclosure.

FIG. 12 is a structural diagram of an unmanned aerial vehicle (UAV) according to an embodiment of the present disclosure.

### DESCRIPTION OF REFERENCE NUMERALS

20—terminal device

21—UAV

22—photographing device

23—gimbal

30—image

31—general marker

70—direction

80—direction

110—terminal device

111—processor

100—UAV

107—motor

106—propeller

117—electronic governor

118—flight controller

108—sensing system

110—communication system

102—support system

104—photographing device

112—ground station

114—antenna

116—electromagnetic wave

### DETAILED DESCRIPTION OF EMBODIMENTS

Technical schemes of the disclosed embodiments will be described with reference to the drawings. It will be appreciated that the described embodiments are some rather than all of the embodiments of the present disclosure. Other embodiments conceived by those having ordinary skills in the art on the basis of the disclosed embodiments without inventive efforts should fall within the scope of the present disclosure.

As used herein, when a component is referred to as “fixed to” another component, the component may be directly attached to the another component or there may be one other component provided between them. When a component is referred to as “connected to” another component, the component may be directly connected to the another component or there may be one other component provided between them.

Unless otherwise defined, all the technical and scientific terms used herein have the same meanings as generally understood by one of ordinary skill in the art. As described herein, the terms used in the specification of the present disclosure are intended to describe exemplary embodiments, rather than limiting the present disclosure. The term “and/or” used herein includes any and all combination of one or more related items listed.

Hereinafter, embodiments of the present disclosure will be described in detail with reference to the drawings. In the situation of no conflict, the embodiments and features of the embodiments can be combined.

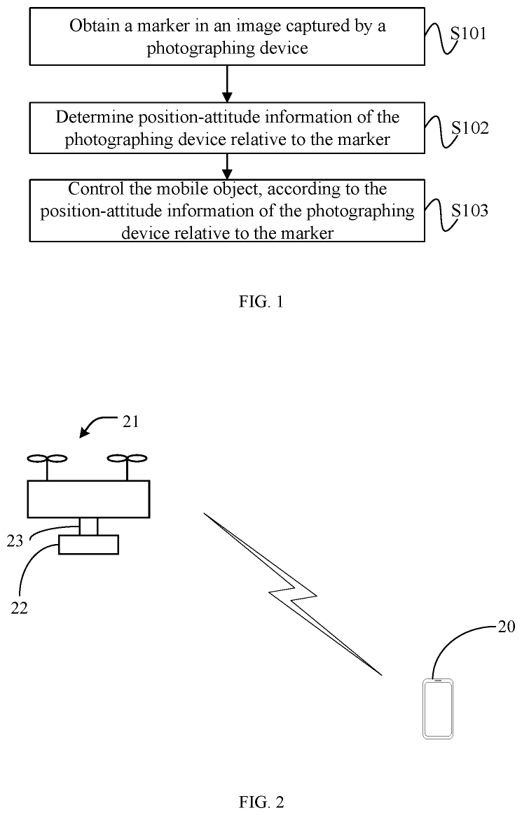

FIG. 1 is a flow chart of an example method for controlling a mobile object consistent with the disclosure. As shown in FIG. 1, at S101, a marker in an image captured by a photographing device is obtained.

FIG. 2 is a schematic diagram of an example system for controlling the mobile object consistent with the disclosure. The method shown in FIG. 1 can be implemented by the system for controlling the mobile object shown in FIG. 2. The mobile object can include an unmanned aerial vehicle (UAV). As shown in FIG. 2, the system for controlling the mobile object includes a terminal device 20 and the mobile object. The mobile object can include a UAV 21. The UAV 21 carries a photographing device 22. For example, the UAV 21 carries the photographing device 22 via a gimbal 23. The terminal device 20 can be a handheld device, such as a mobile terminal, a tablet, or the like. The terminal device 20 can have a photographing function. For example, the terminal device 20 can include a front-facing camera and/or a rear-facing camera. The front-facing camera and/or rear-facing camera can be configured to capture images. A user can hold the terminal device 20 and take selfies using the front-facing camera of the terminal device 20, or shoot other images using the rear-facing camera of the terminal device 20. The user can preview the images captured by the terminal device 20 through a screen of the terminal device 20.

The front-facing camera or the rear-facing camera of the terminal device 20 can capture images of a current scene in real time. Furthermore, the terminal device 20 can detect a marker in the image captured by the front-facing camera or the rear-facing camera. The marker can be a preset marker or a general marker. The preset marker can include at least one of a human face, a two-dimensional barcode, an AprilTag, or another marker with a specific model. The human face is the most common marker. The general marker can be a static object in the image, such as a tree, a car, a building, or the like. The difference between the preset marker and general marker is that the preset marker has a specific model and the general marker has no specific model.

For example, when the user holds the terminal device 20 and takes selfies using the front-facing camera of the terminal device 20, the front-facing camera of the terminal device 20 can capture images of the user's face in real time. The terminal device 20 can identify the face in the image using face recognition technologies. As another example, image information or video data captured by the photographing device 22 carried by the UAV 21 can be wirelessly transmitted to the terminal device 20 via a communication system of the UAV 21. The user can view the image information or video data captured by the photographing device 22 through the terminal device 20. When the user is viewing the image information or the video data captured by the photographing device 22, the front-facing camera of the terminal device 20 may face the user's face, and the front-facing camera of the terminal device 20 can capture images of the user's face in real time. Furthermore, the terminal device 20 can identify the face in the image using the face recognition technologies. For example, because the human face has expressed features, the terminal device 20 can detect the key fixation points of the face in the image, such as the eyes, the nose, the eyebrows, the mouth, or the like, such that the face in the image can be identified through the key fixation points in the image.

In some embodiments, acquiring the marker in the image captured by the photographing device can include, but is not limited to, the following approaches.

One approach is to obtain the marker selected by the user in the image captured by the photographing device. Obtaining the marker selected by the user in the image captured by the photographing device 22 can include at least one of the followings: obtaining the marker selected by the user through drawing a box in the image captured by the photographing device 22, or obtaining the marker selected by the user through clicking the marker in the image captured by the photographing device 22.

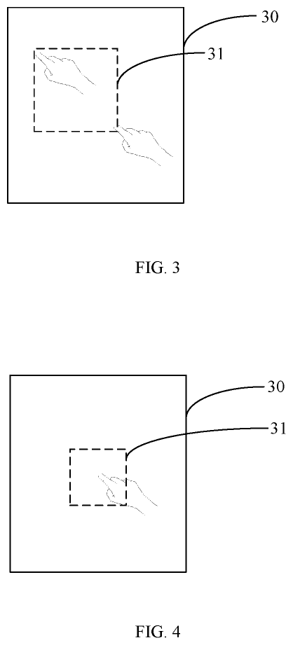

Because there is no specific model for the general marker, the terminal device 20 can obtain the marker selected by the user in the image captured by the terminal device 20. FIG. 3 is a schematic diagram of an example user interface of the terminal device 20 consistent with disclosure. As shown in FIG. 3, an image 30 is captured by the terminal device 20. The image 30 includes a general marker 31. When the terminal device 20 displays the image 30, the user can draw a box, shown as dotted lines in FIG. 3, to select the general marker 31. FIG. 4 is a schematic diagram of another example user interface of the terminal device 20 consistent with the disclosure. In some other embodiments, as shown in FIG. 4, the user can click the image 30 to select the general marker 31.

Another approach is to obtain the marker, in the image captured by the photographing device, that matches a preset reference image. For example, the terminal device 20 can prestore the reference image, such as a reference image of two-dimensional barcode, a reference image of AprilTag, or the like. After a camera of the terminal device 20 captures the image of the current scene, the terminal device 20 can detect whether there is a two-dimension barcode in the image matching the prestored reference image of two-dimensional barcode or an AprilTag in the image matching the prestored reference image of AprilTag, and set an icon matched successfully as the marker.

In some embodiments, the terminal device 20 can prestore a reference image of a general marker, such as a tree, a car, a building, or the like. After the camera of the terminal device 20 captures the image of the current scene, the terminal device 20 can detect whether there is a marker in the image that matches the prestored reference image, such as the tree, the car, the building, or the like.

Another approach is to obtain the marker including a preset number of feature points in the image captured by the photographing device. For the general marker, the terminal device 20 can detect the feature points in the image. If the number of the feature points reaches the preset number and a position relationship between the feature points satisfies a preset position relationship, the terminal device 20 can detect the general marker formed by the preset number of feature points.

At S102, position-attitude information of the photographing device relative to the marker is determined.

After detecting the marker according to the processes described above, the terminal device 20 can further determine the position-attitude information of the terminal device 20 relative to the marker. The position-attitude information can include at least one of position information or attitude information. The attitude information can include at least one of a pitch angle, a roll angle, or a yaw angle.

In some embodiments, determining the position-attitude information of the photographing device relative to the marker can include: determining position-attitude information of the marker in the image captured by the photographing device, and determining the position-attitude information of the photographing device relative to the marker according to the position-attitude information of the marker in the image captured by the photographing device.

Determining the position-attitude information of the marker in the image captured by the photographing device can include: according to coordinates of one or more key points of the marker in the image captured by the photographing device, determining the position-attitude information of the marker in the image captured by the photographing device.

For example, the marker can be a user's face. After detecting the key fixation points of the human face in the image captured by the front-facing camera in real time, the terminal device 20 can determine position-attitude information of the human face in the image (e.g., position information and attitude information of the human face in the image), according to the coordinates of the key fixation points of the human face in the image. The terminal device 20 can further determine the position-attitude information of the terminal device 20 relative to the human face, according to the position-attitude information of the human face in the image. For example, if the human face is in the right part of the image, the terminal device 20 can be determined to be on the left side of the human face.

As another example, the marker can be a general marker. After the terminal device 20 detects feature points of the general marker in the image captured by the rear-facing camera in real time, simultaneous location and mapping (SLAM) method can be used to estimate position-attitude information of the feature points, and the position-attitude information of the feature points can be used as the position-attitude information of the general marker in the image. The terminal device 20 can further determine the position-attitude information of the terminal device 20 relative to the general marker, according to the position-attitude information of the general marker in the image. For example, if the general marker is in the left part of the image, the terminal device 20 can be determined to be on the right side of the general marker. If the general marker is in the right part of the image, the terminal device 20 can be determined to be on the left side of the general marker.

At S103, the mobile object is controlled according to the position-attitude information of the photographing device relative to the marker.

For example, the terminal device 20 can control the UAV 21, according to the position-attitude information of the terminal device 20 relative to the marker. For example, the terminal device 20 can control a position of the UAV 21 according to the position information of the terminal device 20 relative to the marker, or can control an attitude of the UAV 21 according to the attitude information of the terminal device 20 relative to the marker.

In some embodiments, controlling the mobile object according to the position-attitude information of the photographing device relative to the marker can include, but is not limited to, the following implementation manners.

One implementation manner is to control position information of the mobile object relative to a preset origin, according to the position information of the photographing device relative to the marker. Controlling the position information of the mobile object relative to the preset origin according to the position information of the photographing device relative to the marker can include: controlling a distance of the mobile object relative to the preset origin according to a distance of the photographing device relative to the marker.

For example, the terminal device 20 can control position information of the UAV 21 relative to the preset origin, according to the position information of the terminal device 20 relative to the marker. The preset origin can be a current return point of the UAV 21, an initial return point of the UAV 21, or a preset point in a geographic coordinate system, which is not limited herein.

For example, the terminal device 20 can generate a control command for controlling the UAV 21, according to the distance of the terminal device 20 relative to the marker. The control command can be configured to control the distance of the UAV 21 relative to the preset origin. In some embodiments, the distance of the terminal device 20 relative to the marker can be L1, and the terminal device 20 can control the distance of the UAV 21 relative to the preset origin to be L2. The relationship between L1 and L2 is not limited herein. For example, the terminal device 20 is at a distance of 1 meter relative to the marker, and the terminal device 20 can control the UAV 21 to be at a distance of 100 meters relative to the preset origin. The terminal device 20 can send the control command to the UAV 21. The control command can include distance information of 100 meters. After the UAV 21 receives the control command, the UAV 21 can adjust the distance between the UAV 21 and the preset origin according to the control command.

Another implementation manner is to control attitude information of the mobile object, according to the attitude information of the photographing device relative to the marker. Controlling the attitude information of the mobile object according to the attitude information of the photographing device relative to the marker can include: controlling a pitch angle of the mobile object according to a pitch angle of the photographing device relative to the marker, controlling a roll angle of the mobile object according to a roll angle of the photographing device relative to the marker, and controlling a yaw angle of the mobile object according to a yaw angle of the photographing device relative to the marker.

For example, the terminal device 20 can control attitude information of the UAV 21, according to the attitude information of the terminal device 20 relative to the marker. In some embodiments, the terminal device 20 can control a pitch angle of the UAV 21, according to the pitch angle of the terminal device 20 relative to the marker. The terminal device 20 can control a roll angle of the UAV 21, according to the roll angle of the terminal device 20 relative to the marker. The terminal device 20 can control a yaw angle of the UAV 21, according to the yaw angle of the terminal device 20 relative to the marker. For example, the pitch angle of the terminal device 20 relative to the marker is α1, the terminal device 20 can control the pitch angle of the UAV 21 to be α2. The relationship between α1 and α2 is not limited herein. In some embodiments, the relationship between α1 and α2 can be a preset proportional relationship.

Another implementation manner is to control a moving speed of the mobile object, according to the attitude information of the photographing device relative to the marker. Controlling the moving speed of the mobile object according to the attitude information of the photographing device relative to the marker can include: controlling a speed at which the mobile object moves along the Y-axis of the ground coordinate system, according to the pitch angle of the photographing device relative to the marker, controlling a speed at which the mobile object moves along the X-axis of the ground coordinate system, according to the roll angle of the photographing device relative to the marker, and controlling a speed at which the mobile object moves along the Z-axis of the ground coordinate system, according to the yaw angle of the photographing device relative to the marker.

In some embodiments, the terminal device 20 can control a moving speed of the UAV 21, according to the attitude information of the terminal device 20 relative to the marker. For example, the terminal device 20 can control a speed at which the UAV 21 moves along the Y-axis of the ground coordinate system, according to the pitch angle of the terminal device 20 relative to the marker. The terminal device 20 can control a speed at which the UAV 21 moves along the X-axis of the ground coordinate system, according to the roll angle of the terminal device 20 relative to the marker. The terminal device 20 can control a speed at which the UAV 21 moves along the Z-axis of the ground coordinate system, according to the yaw angle of the terminal device 20 relative to the marker. These are merely examples, and do not intend to limit the correspondence between the attitude angle and the moving direction.

In the embodiment, the position-attitude information of the photographing device relative to the marker can be determined by obtaining the marker in the image captured by the photographing device, and the mobile object can be controlled according to the position-attitude information of the photographing device relative to the marker. Since the position-attitude information of the photographing device relative to the marker can be precisely determined, the precise control of the mobile object can be realized when the mobile object is controlled according to the position-attitude information of the photographing device relative to the marker.

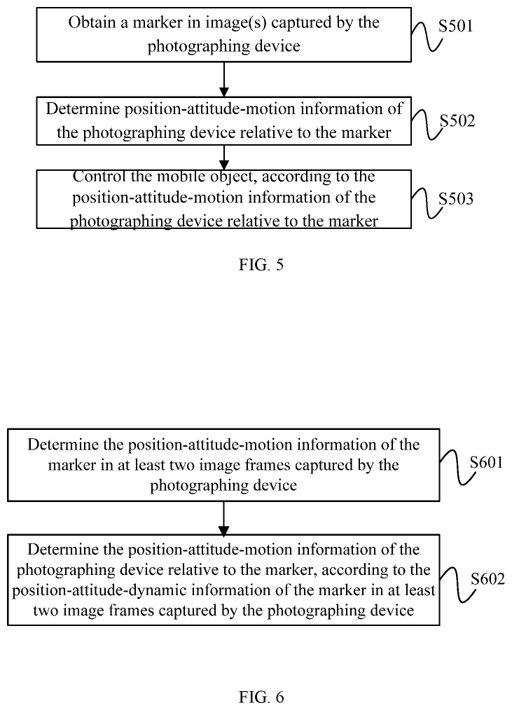

FIG. 5 is a flow chart of another example method for controlling the mobile object consistent with the disclosure. As shown in FIG. 5, at S501, a marker in image(s) captured by the photographing device is obtained.

The process at S501 and the process at S101 are similar, description of which is omitted here.

At S502, position-attitude-motion information of the photographing device relative to the marker is determined.

In the embodiment, after the terminal device 20 detects the marker, the position-attitude-motion information of the photographing device 20 relative to the marker can be further determined. The position-attitude-motion information can include at least one of position-change information or attitude-change information. For example, the marker can be a user's face. The front-facing camera of the terminal device 20 can face the user's face and capture images including the user's face in real time. Assume that the user's face is not moving and the user moves the terminal device 20. The user's face moving toward the right in the images indicates that the terminal device 20 is moving toward left relative to the user's face. As another example, the marker can be a general marker. The rear-facing camera of the terminal device 20 can face the general marker and capture images including the general marker in real time. Assume that the general marker is not moving and the user moves the terminal device 20. The general marker moving toward the right in the images indicates that the terminal device 20 is moving toward left relative to the general marker. Similarly, a change of attitude of the terminal device 20 relative to the marker can also be determined. It can be appreciated that the terminal device 20 can detect the marker in the images captured by the front-facing camera or the rear-facing camera in real time and determine the change of position or the change of attitude of the marker in the images. Furthermore, the terminal device 20 can deduce the change of position of the terminal device 20 relative to the marker, according to the change of the position of the marker in the images, or can deduce the change of attitude of the terminal device 20 relative to the marker, according to the change of the attitude of the marker in the images.

At S503, the mobile object is controlled according to the position-attitude-motion information of the photographing device relative to the marker.

In some embodiments, the terminal device 20 can also map the change of position of the terminal device 20 relative to the marker into a control command for controlling the UAV 21 or map the change of attitude of the terminal device 20 relative to the marker into a control command for controlling the UAV 21, and send the control command to the UAV 21.

In some embodiments, controlling the mobile object according to the position-attitude-motion information of the photographing device relative to the marker can include, but is not limited to, the following several situations.

One situation is to control the position-change information of the mobile object relative to a preset origin, according to the position-change information of the photographing device relative to the marker.

For example, when the terminal device 20 is moving toward the left relative to the user's face, the terminal device 20 can control the UAV 21 to move toward the left relative to the preset origin or move toward the right relative to the preset origin. As another example, when the terminal device 20 is moving toward the right relative to the general marker, the terminal device 20 can control the UAV 21 to move toward the right relative to the preset origin or move toward the left relative to the preset origin. The preset origin can be a current return point of the UAV 21, an initial return point of the UAV 21, or a preset point in a geographic coordinate system, which is not limited herein.

Another situation is to control the attitude-change information of the mobile object relative to the preset origin, according to the attitude-change information of the photographing device relative to the marker.

Assume that the marker is not moving. A change of attitude of the terminal device 20 relative to the marker can include a change of pitch angle of the terminal device 20 relative to the marker, such as a pitch angular velocity, a change of roll angle of the terminal device 20 relative to the marker, such as a roll angular velocity, or a change of yaw angle of the terminal device 20 relative to the marker, such as a yaw angular velocity. For example, the terminal device 20 can control a pitch angular velocity of the UAV 21 relative to the preset origin, according to the pitch angular velocity of the terminal device 20 relative to the marker. The terminal device 20 can control a roll angular velocity of the UAV 21 relative to the preset origin, according to the roll angular velocity of the terminal device 20 relative to the marker. The terminal device 20 can control a yaw angular velocity of the UAV 21 relative to the preset origin, according to the yaw angular velocity of the terminal device 20 relative to the marker.

In the embodiment, the position-change information or the attitude-change information of the photographing device relative to the marker can be determined by obtaining the marker in the images captured by the photographing device, and the change of position of the mobile object can be controlled according to the position-change information of the photographing device relative to the marker, or the change of attitude of the mobile object can be controlled according to the attitude-change information of the photographing device relative to the marker. Since the position-change information or the attitude-change information of the photographing device relative to the marker can be precisely determined, the mobile object can be precisely controlled according to the position-change information or the attitude-change information of the photographing device relative to the marker.

FIG. 6 is a flow chart of another example method for controlling the mobile object consistent with the disclosure. As shown in FIG. 6, the method for determining the position-attitude-motion information of the photographing device relative to the marker at S502 can include the following implementation manners.

As shown in FIG. 6, at S601, the position-attitude-motion information of the marker in at least two image frames captured by the photographing device is determined.

In some embodiments, determining the position-attitude-motion information of the marker in the at least two image frames captured by the photographing device can include: according to first coordinates of one or more key points of the marker in a first image captured by the photographing device and second coordinates of the one or more key points of the marker in a second image captured by the photographing device, a correlation matrix between the first image and the second image can be determined. According to the correlation matrix between the first image and the second image, the position-attitude-motion information of the marker in the first image and the second image can be determined.

For example, the marker can be a user's face. The front-facing camera of the terminal device 20 can capture the images including the user's face in real time. The terminal device 20 can obtain a plurality of two-dimensional key points of the human face in the image, denoted as \vec{u}ᵢ=(uᵢ, vᵢ),i=1,2,3 . . . n, through a face detection method. According to priori knowledge of human face, the two-dimensional key points can be transformed into three-dimensional key points, denoted as Xᵢ=(xᵢ,yᵢ,zᵢ),i=1,2,3 . . . n.

As another example, the marker can be a general marker. The rear-facing camera of the terminal device 20 can capture the images including the general marker in real time. The terminal device 20 can use a preset initialization method to obtain a series of two-dimensional key points of the general marker in the image. In some embodiments, the two-dimensional key points can be expressive feature points, such as Harris corner points or FAST corner points. The terminal device 20 can further track the two-dimensional key points between two image frames captured by the rear-facing camera, for example, the two-dimensional key points can be tracked between two adjacent image frames. Assume that the two-dimensional key points (uᵢ, vᵢ) of a previous frame correspond to the two-dimensional key points (u′ᵢ, v′ᵢ) of a succeeding frame, and an internal reference matrix of the rear-facing camera of the terminal device 20 is K. The terminal device 20 can employ a triangulation method to convert the series of two-dimensional key points of the general mark in the image into three-dimensional key points Xᵢ. Herein, the triangulation method can specifically be a Direct Linear Transform (DLT). Assume that a projection matrix of the previous frame is

$$P = [ \begin{matrix}{p}^{1 T} \\ {p}^{2 T} \\ {p}^{3 T}\end{matrix} ] ,$$

and a projection matrix of the succeeding frame is

$${P}^{′} = [ \begin{matrix}{p}^{{}^{′} 1 T} \\ {p}^{{}^{′} 2 T} \\ {p}^{{}^{′} 3 T}\end{matrix} ] ,$$

where p^{1T} represents the first row of P, p^{2T} represents the second row of P, p^{3T} represents the third row of P, p′^{1T} represents the first row of P′, p′^{2T} represents the second row of P′, p′^{3T} represents the third row of P′. The relationship between the projection matrix P of the previous frame, the three-dimensional points Xᵢ, and the two-dimensional key points (uᵢ, vᵢ) of the previous frame can be determined by the following formula (1).

$$[ \begin{matrix}{u}_{i} \\ {v}_{i} \\ 1\end{matrix} ] = {PX}_{i} \qquad ( 1 )$$

The relationship between the projection matrix P′ of the succeeding frame, the three-dimensional key points Xᵢ, and the two-dimensional key points (u′ᵢ, v′ᵢ) of the succeeding frame can be determined by the following formula (2).

$$[ \begin{matrix}{u}_{i}^{′} \\ {v}_{i}^{′} \\ 1\end{matrix} ] = {P}^{′} {X}_{i} \qquad ( 2 )$$

The relationship between the projection matrix P of the previous frame, the projection matrix P′ of the succeeding frame, the three-dimensional points Xᵢ, the two-dimensional key points (uᵢ, vᵢ) of the previous frame, and the two-dimensional key points (u′ᵢ, v′ᵢ) of the succeeding frame can be determined by the following formula (3).

$$[ \begin{matrix}{u}_{i} {p}^{3 T} - {p}^{1 T} \\ {v}_{i} {p}^{3 T} - {p}^{2 T} \\ {u}_{i}^{′} {p}^{{}^{′} 3 T} - {p}^{{}^{′} 1 T} \\ {v}_{i}^{′} {p}^{{}^{′} 3 T} - {p}^{{}^{′} 2 T}\end{matrix} ] {X}_{i} {=}^{Δ} {AX}_{i} = 0 \qquad ( 3 )$$

where A denotes a matrix. A right eigenvector corresponding to a minimum eigenvalue of the matrix A is a solution of the three-dimensional points Xᵢ. The projection matrix P of the previous frame and the projection matrix P′ of the succeeding frame can be obtained from the fundamental matrix F.

When three-dimensional points of the marker can be detected in each image frame, the correlation matrix between two adjacent frames can be determined. For example, the processes can be as follows.

The three-dimensional points corresponding to two adjacent frames can be represented as the homogeneous coordinate form. For example, Xᵢ=(xᵢ, yᵢ, zᵢ) represents the three-dimensional points of the previous frame, a homogeneous coordinate form of Xᵢ(xᵢ, yᵢ, zᵢ) can be

$${P}_{i} = ( \begin{matrix}{x}_{i} \\ {y}_{i} \\ {z}_{i} \\ 1\end{matrix} ) .$$

X′ᵢ=(x′ᵢ, y′ᵢ, z′ᵢ) represents the three-dimensional points of the succeeding frame, a homogeneous coordinate form of X′ᵢ=(x′ᵢ, y′ᵢ, z′ᵢ) can be

$${P}_{i}^{′} = ( \begin{matrix}{x}_{i}^{′} \\ {y}_{i}^{′} \\ {z}_{i}^{′} \\ 1\end{matrix} ) .$$

The relationship between the homogeneous coordinate form Pi of Xᵢ=(xᵢ, yᵢ, zᵢ), the homogeneous coordinate form P′i of X′ᵢ=(x′ᵢ, y′ᵢ, z′ᵢ), and the correlation matrix M between two adjacent frames can be determined by the following formula (4).

P′ᵢ=MPᵢ (4)

where M can be expresses as the form of formula (5).

$$M = [ \begin{matrix}{R}_{3 \times 3} & {T}_{3 \times 1} \\ 0 & 1\end{matrix} ] \qquad ( 5 )$$

The correlation matrix includes a rotation matrix and a translation vector. The rotation matrix represents the attitude-change information of the one or more key points in the first image and the second image. The translation vector represents the position-change information of the one or more key points in the first image and the second image. For example, R_{3×3} denotes the rotation matrix representing the attitude-change information of key points of the marker in the previous and succeeding frames. T_{3×1} denotes the translation vector representing the position-change information of key points of the marker in the previous and succeeding frames.

In some embodiments, M can be calculated by optimizing a cost function shown in formula (6).

M*=arg min|(MP−P′)V|² (6)

where V represents a visual matrix, and when a feature point i can be observed in both two frames, for example, two adjacent frames, V(i,:)=1; otherwise, V(i,:)=0.

In addition, in order to improve the calculation accuracy of M, the formula (6) can also be optimized. The optimization methods can include the followings.

Random sample consensus (RANSAC) method can be used to select some feature points to reduce the influence of outliers, and a nonlinear optimization method, such as Levenberg-Marquardt (LM), can be used to further optimize the formula (6).

In some embodiments, when there are only two-dimensional points in a current frame of the marker, for example, the marker is the general marker, R and T can be calculated using the perspective-n-point (PnP) method, and the nonlinear optimization method, such as LM, can be further used to minimize a target function as shown in the following formula (7).

$$min {\sum }_{i} {\vert {\vec{u}}_{i} - K ( {RX}_{i} + T ) \vert}^{2} \qquad ( 7 )$$

where R can be R_{3×3} in formula (5), and T can be T_{3×1} in formula (5). In some embodiments, the RANSAC method can be used to select some feature points to reduce the influence of outliers.

After calculating the correlation matrix M between the previous frame and the succeeding frame, the terminal device 20 can determine the position-attitude-motion information of the marker in the previous frame and the succeeding frame according to the correlation matrix. In some embodiments, the position-attitude-motion information includes position-change information and attitude-change information. According to formula (5), R_{3×3} denotes the rotation matrix representing the attitude-change information of key points of the marker in the previous and succeeding frames. Therefore, the terminal device 20 can determine the attitude-change information of the marker in the previous and succeeding frames, according to the attitude-change information of key points of the marker in the previous and succeeding frames. In addition, according to formula (5), T_{3×1} denotes the translation vector representing the position-change information of key points of the marker in the previous and succeeding frames. Therefore, the terminal device 20 can determine the position-change information of the marker in the previous and succeeding frames, according to the position-change information of key points of the marker in the previous and succeeding frames.

At S602, the position-attitude-motion information of the photographing device relative to the marker is determined, according to the position-attitude-motion information of the marker in the at least two image frames captured by the photographing device.

In some embodiments, the terminal device 20 can determine the attitude-change information of the terminal device 20 relative to the marker, according to the attitude-change information of the marker in the previous and succeeding frames captured by the terminal device 20, or can determine the position-change information of the terminal device 20 relative to the marker, according to the position-change information of the marker in the previous and succeeding frames captured by the terminal device 20.

In other embodiments, the terminal device 20 can also use R_{3×3} and T_{3×1} as input signals of a proportional integral derivative (PID) controller, such that the controller can output the control command for controlling the UAV 21. R_{3×3} can be configured to control the attitude of the UAV 21. For example, the terminal device 20 can convert R_{3×3} into Euler angles, and generate a control command for controlling the UAV 21 to rotate based on the Euler angles. T_{3×1} can be configured to control the translation of the UAV 21. R_{3×3} and T_{3×1} can use a common controller or R_{3×3} and T_{3×1} can use two different controllers.

The second implementation manner for determining the position-attitude-motion information of the photographing device relative to the marker is to determine the position-attitude-motion information of the photographing device relative to the marker according to the position-attitude-motion information of the photographing device detected by the IMU.

For example, the terminal device 20 can be provided with an IMU. The IMU can include one or more gyroscopes and one or more accelerometers. The IMU can be configured to detect the pitch angle, the roll angle, the yaw angle, an acceleration, and/or the like, of the terminal device 20. Assuming that the markers are different in the previous and succeeding frames, the terminal device 20 can determine the attitude-change information of the terminal device 20 relative to the marker, according to the attitude-change information of the terminal device 20 detected by the IMU, or can further determine the position-change information of the terminal device 20 relative to the marker, according to the position-change information of the terminal device 20 calculated from the acceleration of the terminal device 20 detected by the IMU.

The third implementation manner for determining the position-attitude-motion information of the photographing device relative to the marker is to determine the position-attitude-motion information of the photographing device relative to the marker, according to the position-attitude-motion information of the marker in at least two image frames captured by the photographing device and the position-attitude-motion information of the photographing device detected by the IMU.

In some embodiments, the attitude-change information or the position-change information of the terminal device 20 relative to the marker can be determined by combining the above two implementation manners for determining the position-attitude-motion information of the photographing device relative to the marker. For example, the terminal device 20 determines the position-attitude-motion information of the terminal device 20 relative to the marker, by comparing the position-attitude-motion information of the marker in at least two image frames captured by the photographing device and the position-attitude-motion information of the terminal device 20 detected by the IMU of the terminal device 20.

In some embodiments, if an absolute value of a difference between the position-attitude-motion information of the photographing device determined according to the position-attitude-motion information of the marker in the at least two image frames captured by the photographing device and the position-attitude-motion information of the photographing device detected by the IMU is greater than a threshold, determined position-attitude-motion information of the photographing device relative to the marker can be deleted.

For example, if the position-attitude-motion information of the terminal device 20 determined by the terminal device 20 according to the position-attitude-motion information of the marker in the at least two image frames captured by the terminal device 20 and the position-attitude-motion information of the terminal device 20 detected by the IMU are inconsistent and the difference is large, it indicates that the position-attitude-motion information of the terminal device 20 relative to the marker determined by the terminal device 20 is inaccurate. Furthermore, the position-attitude-motion information of the terminal device 20 relative to the marker determined before a current moment can be initialized, for example, can be deleted.

Consistent with the embodiment, the correlation matrix between two image frames can be determined based on the coordinates of one or more key points of the marker in at least two image frames captured by the terminal device, and the position-attitude-motion information of the marker in the two image frames can be determined according to the correlation matrix. The position-attitude-motion information of the terminal device relative to the marker can be further determined, according to the position-attitude-motion information of the marker in the two image frames. As such, the calculation accuracy of the position-attitude-motion information of the terminal device relative to the marker can be improved.

In some embodiments, on the basis of the methods shown in FIGS. 1, 5, and 6, before controlling the mobile object, the method also includes obtaining a trigger command for triggering a movement of the mobile device. The trigger command can be generated by operating on a first activation button.

According to the above embodiments, the user can control the UAV 21 through the terminal device 20. For example, when the front-facing camera of the terminal device 20 captures the user's face, the terminal device 20 can move toward the left relative to the user's face, and further map the movement direction of the terminal device 20 relative to the user's face to the control command for controlling the UAV 21. The situation that the terminal device 20 moves toward the left relative to the user's face can include, but is not limited to, the following situations.

FIG. 7 is a schematic diagram showing the terminal device 20 moving relative to the user's face consistent with the disclosure. As shown in FIG. 7, the user's face does not move and the user moves the terminal device 20 toward the left as in a direction denoted by an arrow 70.

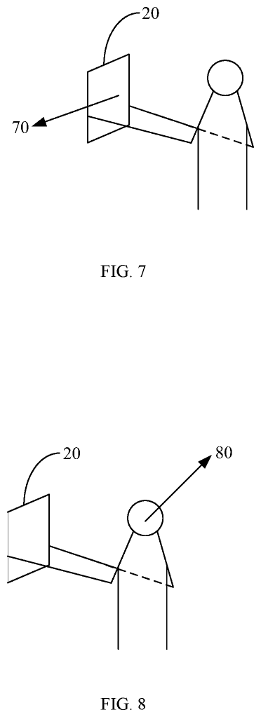

FIG. 8 is another schematic diagram showing the terminal device 20 moving relative to the user's face consistent with the disclosure. As shown in FIG. 8, the terminal device 20 does not move and the user's face moves toward the right as in a direction denoted by an arrow 80.

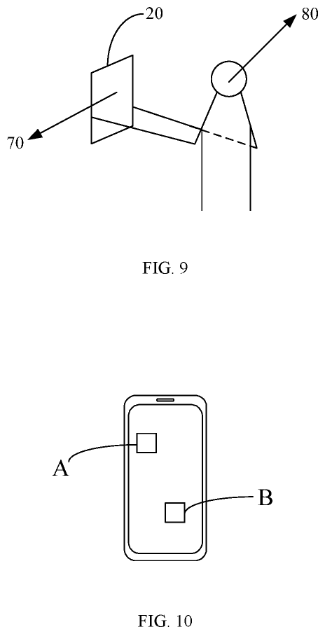

FIG. 9 is another schematic diagram showing the terminal device 20 moving relative to the user's face consistent with the disclosure. As shown in FIG. 9, the user's face and the terminal device 20 are moving simultaneously. The user moves the terminal device 20 toward the left as in a direction denoted by the arrow 70, and the user's face moves toward the right as in a direction denoted by the arrow 80.

As shown in FIGS. 7 to 9, the change of position and attitude of the user's face or the change of position and attitude of the terminal device 20 itself can both cause the change of position and attitude of the terminal device 20 relative to the user's face. The terminal device 20 can control the UAV 21 according to the change of position and attitude of the terminal device 20 relative to the user's face.

Sometimes the user may inadvertently turn the head or inadvertently move the terminal device 20, which may also cause the change of position and attitude of the UAV 21. In this situation, the user may not want the change of position and attitude of the UAV 21. In order to avoid the change of position and attitude of the UAV 21 caused by the accidental operation of the user, an activation button, such as the activation button A shown in FIG. 10, can be provided on the terminal device 20. When the user clicks the activation button A, the terminal device 20 can generate the trigger command according to the click operation on the activation button A performed by the user. The trigger command can trigger the terminal device 20 to send the control command to the UAV 21. If the user does not click the activation button A, the terminal device 20 cannot send the control command to the UAV 21 even if the control device 20 generates the control command, such that it can be ensured that the UAV 21 does not move. In some embodiments, the trigger command can also trigger the UAV 21 to move. For example, when the UAV 21 receives both the control command and the trigger command sent by the terminal device 20, the UAV 21 can execute the control command. If the UAV 21 only receives the control command sent by the terminal device 20 and does not receive the trigger command sent by terminal device 20, the control command will not be executed.

In some embodiments, before determining the position-attitude information of the photographing device relative to the marker, the method may further include obtaining an initialization command. The initialization command can be configured to initialize the determined position-attitude information of the photographing device relative to the marker. The initialization command can be generated by operating on a second activation button.

FIG. 10 is a schematic diagram of another example user interface of the terminal device 20 consistent with the disclosure. As shown in FIG. 10, the terminal device 20 can also be provided with an activation button B. The activation button A can be also referred to as a first activation button A and the activation button B can be also referred to as a second activation button B. When the user clicks the activation button B, the terminal device 20 can generate the initialization command according to the click operation on the activation button B performed by the user. The initialization command can be configured to initialize, such as delete, the position-attitude-motion information of the terminal device 20 relative to the marker determined before the current moment. For example, before the user controls the UAV 21 through the terminal device 20, the terminal device 20 may store the position-attitude-motion information of the terminal device 20 relative to the marker, such as the user's face, determined at a historical moment. In order to avoid the influence of the position-attitude-motion information determined at the historical moment on the position-attitude-motion information determined at the current moment, the user can initialize the position-attitude-motion information of the terminal device 20 relative to the marker, such as the user's face, determined by the terminal device 20 at the historical moment by clicking the activation button B.

Consistent with the disclosure, the operation on the first activation button A of the terminal device 20 performed by the user can cause the terminal device 20 to generate the trigger command for triggering the UAV 21 to move. The change of position and attitude of the UAV 21 due to the user's misoperation can be avoid and the accurate control of the UAV 21 can be realized. In addition, the operation on the second activation button B of the terminal device 20 performed by the user can cause the terminal device 20 to generate the initialization command for initializing the determined position and attitude information of the terminal device 20 relative to the marker. The influence of the position-attitude-motion information determined at the historical moment on the position-attitude-motion information determined at the current moment can be avoid. The accurate control of the UAV 21 can be further realized.

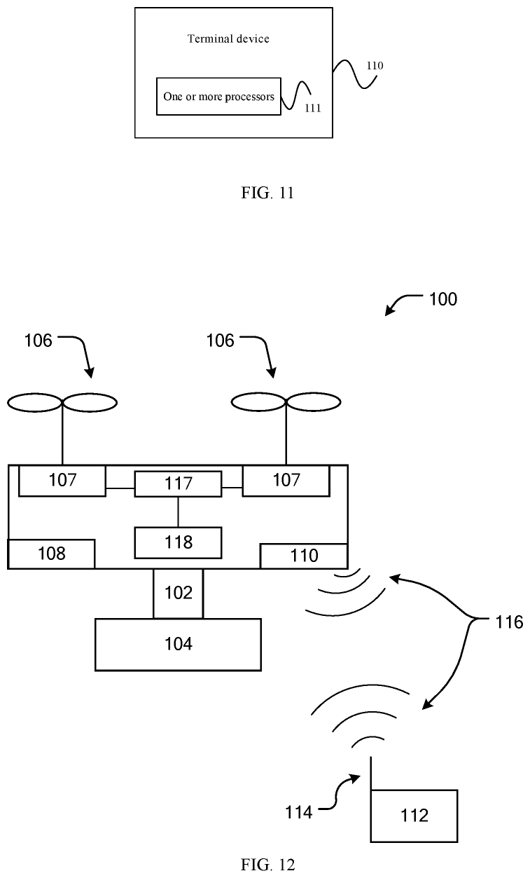

FIG. 11 is a structural diagram of an example terminal device 110 consistent with the disclosure. As shown in FIG. 11, the terminal device 110 includes one or more processors 111. The one or more processors 111 can be configured to obtain the marker in the image captured by the photographing device, determine the position-attitude information of the photographing device relative to the marker, and control the mobile object according to the position-attitude information of the photographing device relative to the marker.

In some embodiments, the position-attitude information can include at least one of the position information ord the attitude information. The attitude information can include at least one of the pitch angle, the roll angle, or the yaw angle.

In some embodiments, when obtaining the marker in the image captured by the photographing device, the one or more processors 111 can be configured to perform at least one of obtaining the marker selected by the user in the image captured by the photographing device, obtaining the marker in the image captured by the photographing device that matches the preset reference image, or obtaining the marker in the image captured by the photographing device that is formed by the preset number of feature points.

In some embodiments, when obtaining the marker selected by the user in the image captured by the photographing device, the one or more processors 111 can be configured to perform at least one of obtaining the marker selected by the user through drawing a box in the image captured by the photographing device, or obtaining the marker selected by the user through clicking the image captured by the photographing device.

In some embodiments, when determining the position-attitude information of the photographing device relative to the marker, the one or more processors 111 can be configured to determine the position-attitude information of the marker in the image captured by the photographing device, and determine the position-attitude information of the photographing device relative to the marker, according to the position-attitude information of the marker in the image captured by the photographing device. When determining the position-attitude information of the marker in the image captured by the photographing device, the one or more processors 111 can be configured to determine the position-attitude information of the marker in the image captured by the photographing device, according to the coordinates of one or more key points of the marker in the image captured by the photographing device.

In some embodiments, when controlling the mobile object according to the position-attitude information of the photographing device relative to the marker, the one or more processors 111 can be configured to perform at least one of controlling the position information of the mobile object relative to the preset origin, according to the position information of the photographing device relative to the marker, controlling the attitude information of the mobile object, according to the attitude information of the photographing device relative to the marker, or controlling the moving speed of the mobile object, according to the attitude information of the photographing device relative to the marker. When controlling the moving speed of the mobile object, according to the attitude information of the photographing device relative to the marker, the one or more processors 111 can be configured to control the speed at which the mobile object moves along the Y-axis in the ground coordinate system, according to the pitch angle of the photographing device relative to the marker, control the speed at which the mobile object moves along the X-axis in the ground coordinate system, according to the roll angle of the photographing device relative to the marker, and control the speed at which the mobile object moves along the Z-axis in the ground coordinate system, according to the yaw angle of the photographing device relative to the marker. When controlling the attitude information of the mobile object, according to the attitude information of the photographing device relative to the marker, the one or more processors 111 can be configured to control the pitch angle of the mobile object according to the pitch angle of the photographing device relative to the marker, control the roll angle of the mobile object according to the roll angle of the photographing device relative to the marker, and control the yaw angle of the mobile object according to the yaw angle of the photographing device relative to the marker. When controlling the position information of the mobile object relative to the preset origin, according to the position information of the photographing device relative to the marker, the one or more processors 111 can be configured to control the distance of the mobile object relative to the preset origin according to the distance of the photographing device relative to the marker.

The specific principle and implementation of the terminal device 110 shown in FIG. 11 are similar to those of the method shown in FIG. 1, description of which is omitted here.

Consistent with the disclosure, the position-attitude information of the photographing device relative to the marker can be determined by obtaining the marker in the image captured by the photographing device, and the mobile object can be controlled according to the position-attitude information of the photographing device relative to the marker. Since the position-attitude information of the photographing device relative to the marker can be precisely determined, the precise control of the mobile object can be realized when the mobile object is controlled according to the position-attitude information of the photographing device relative to the marker.

On the basis of the terminal device 110 shown in FIG. 11, the one or more processors 111 can be further configured to determine the position-attitude-motion information of the photographing device relative to the marker, and control the mobile object according to the position-attitude-motion information of the photographing device relative to the marker. The position-attitude-motion information can include at least one of the position-change information or the attitude-change information.

In some embodiments, when controlling the mobile object according to the position-attitude-motion information of the photographing device relative to the marker, the one or more processors 111 can be configured to perform at least one of controlling the position-change information of the mobile object relative to the preset origin, according to the position-change information of the photographing device relative to the marker, or controlling the attitude-change information of the mobile object relative to the preset origin, according to the attitude-change information of the photographing device relative to the marker.

The specific principle and implementation of the terminal device 110 shown in FIG. 11 are similar to those of the method shown in FIG. 5, description of which is omitted here.

Consistent with the disclosure, the position-change information or the attitude-change information of the photographing device relative to the marker can be determined by obtaining the marker in the images captured by the photographing device, and the change of position of the mobile object can be controlled according to the position-change information of the photographing device relative to the marker, or the change of attitude of the mobile object can be controlled according to the attitude-change information of the photographing device relative to the marker. Since the position-change information or the attitude-change information of the photographing device relative to the marker can be precisely determined, the mobile object can be precisely controlled according to the position-change information or the attitude-change information of the photographing device relative to the marker.

The one or more processors 111 determining the position-attitude-motion information of the photographing device relative to the marker can include, but is not limited to, the following implementation manners.

One implementation manner is that when determining the position-attitude-motion information of the photographing device relative to the marker, the one or more processors 111 can be configured to determine the position-attitude-motion information of the marker in the at least two image frames captured by the photographing device, and determine the position-attitude-motion information of the photographing device relative to the marker, according to the position-attitude-motion information of the marker in the at least two image frames captured by the photographing device. When determining the position-attitude-motion information of the marker in the at least two image frames captured by the photographing device, the one or more processors 111 can be configured to, according to the first coordinates of the one or more key points of the marker in the first image captured by the photographing device and the second coordinates of the one or more key points of the marker in the second image captured by the photographing device, determine the correlation matrix between the first image and the second image, and determine the position-attitude-motion information of the marker in the first image and the second image, according to the correlation matrix between the first image and the second image. The correlation matrix includes the rotation matrix and the translation vector. The rotation matrix represents the attitude-change information of the one or more key points in the first image and the second image. The translation vector represents the position-change information of the one or more key points in the first image and the second image.

Another implementation manner is that when determining the position-attitude-motion information of the photographing device relative to the marker, the one or more processors 111 can be configured to determine the position-attitude-motion information of the photographing device relative to the marker according to the position-attitude-motion information of the photographing device detected by the IMU.

A further implementation manner is that when determining the position-attitude-motion information of the photographing device relative to the marker, the one or more processors 111 can be configured to determine the position-attitude-motion information of the photographing device relative to the marker, according to the position-attitude-motion information of the marker in the at least two image frames captured by the photographing device and the position-attitude-motion information of the photographing device detected by the IMU. If the absolute value of the difference between the position-attitude-motion information of the photographing device determined according to the position-attitude-motion information of the marker in the at least two image frames captured by the photographing device and the position-attitude-motion information of the photographing device detected by the IMU is greater than the threshold, the one or more processors 111 can be further configured to delete determined position-attitude-motion information of the photographing device relative to the marker.

The specific principle and implementation of the terminal device 110 shown in

FIG. 11 are similar to those of the method shown in FIG. 6, description of which is omitted here.

Consistent with the disclosure, the correlation matrix between two image frames can be determined by the coordinates of one or more key points of the marker in at least two image frames captured by the terminal device, and the position-attitude-motion information of the marker in the two image frames can be determined according to the correlation matrix. The position-attitude-motion information of the terminal device relative to the marker can be further determined, according to the position-attitude-motion information of the marker in the two image frames. As such, the calculation accuracy of the position-attitude-motion information of the terminal device relative to the marker can be improved.

In some embodiments, before controlling the mobile object, the one or more processors 111 can be also configured to obtain the trigger command for triggering the movement of the mobile device. The trigger command can be generated by operating on the first activation button.

In some embodiments, before determining the position-attitude information of the photographing device relative to the marker, the one or more processors 111 can be also configured to obtain the initialization command. The initialization command is configured to initialize the determined position-attitude information of the photographing device relative to the marker. The initialization command can be generated by operating on the second activation button.

The specific principle and implementation of the terminal device 110 shown in FIG. 11 are similar to those of the method shown in FIG. 10, description of which is omitted here.

Consistent with the disclosure, the operation on the first activation button of the terminal device 110 performed by the user can cause the terminal device 110 to generate the trigger command for triggering the UAV to move. The change of position and attitude of the UAV due to the user's misoperation can be avoid and the accurate control of the UAV can be realized. In addition, the operation on the second activation button of the terminal device 110 performed by the user can cause the terminal device 110 to generate the initialization command for initializing the determined position and attitude information of the terminal device relative to the marker. The influence of the position-attitude-motion information determined at the historical moment on the position-attitude-motion information determined at the current moment can be avoided. The accurate control of the UAV can be further realized.

FIG. 12 is a structural diagram of an example UAV 100 consistent with the disclosure. As shown in FIG. 12, the UAV 100 includes a fuselage, a power system, and a flight controller 118. The power system includes at least one of motors 107, propellers 106, or an electronic governor 117. The power system is provided on the fuselage and configured to provide power for flight. The flight controller 118 can be communicatively connected to the power system and configured to control the flight of the UAV.

As shown in FIG. 12, the UAV 100 also includes a sensing system 108, a communication system 110, a support device 102, and a photographing device 104. The support device 102 can include a gimbal. The communication system 110 can include a receiver. The receiver can be configured to receive a wireless signal transmitted by an antenna 114 of a ground station 112. Reference numeral 116 denotes electromagnetic waves generated during the communication between the receiver and the antenna 114.

The ground station 112 can include the terminal device shown in FIGS. 2 and 11.

The terminal device can generate control commands and send the control commands to the flight controller 118 through the communication system 110 of the UAV 100. The flight controller 118 can further control the UAV 100 according to the control commands sent by the terminal device. The specific principle and implementation of the terminal device controlling the UAV 100 are similar to those of the terminal device 20 shown in FIG. 2 and the terminal device 110 shown in FIG. 11, description of which is omitted here.

The mobile object can include a UAV. As shown in FIG. 2, a control system of the mobile object includes the terminal device 20 and the UAV 21. The specific principle and implementation of the terminal device 20 controlling the UAV 21 are similar to those of the above embodiments, description of which is omitted here.

According to the method, apparatus, and system for controlling the mobile object provided by the present disclosure, the position-attitude information of the photographing device relative to the marker can be determined by obtaining the marker in the image captured by the photographing device, and the mobile object can be controlled according to the position-attitude information of the photographing device relative to the marker. Since the position-attitude information of the photographing device relative to the marker can be precisely determined, the precise control of the mobile object can be realized when the mobile object is controlled according to the position-attitude information of the photographing device relative to the marker.

Consistent with the disclosure, it should be appreciated that the disclosed apparatus and methods can be implemented in other manners. For example, the embodiments of the apparatus described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physical unit, or two or more units may be integrated in one unit. The above-described integrated units can be implemented in the form of hardware or in the form of hardware plus software functional units.

The above-described integrated unit implemented in the form of software functional units can be stored in a computer-readable storage medium. The above-described software functional units can include instructions that enable a computer device, such as a personal computer, a server, or a network device, or a processor to perform part of the methods according to various embodiments of the present disclosure. The above-described storage medium can be any medium that can store program codes, for example, a USB disk, a mobile hard disk, a read-only memory (ROM), a random access memory (RAM), a magnetic disk, or an optical disk.

Those skilled in the art may clearly understand that, for the convenience and simplicity of the description, the divisions of the above-described functional modules are merely used as examples. In practice, the above functions may be assigned to different functional modules for completion, according to the needs. That is, the internal structure of the device can be divided into different functional modules to complete all or part of the functions described above. For specific working processes of the above-described apparatus, reference may be made to the corresponding processes in the above-described embodiments of method, description of which is omitted here.

It should be noted that the above-described embodiments are merely for describing the technical solutions of the present disclosure, but are not intend to limit the present disclosure. Although the present disclosure has been described in detail with reference to the various embodiments described above, it will be apparent to those skilled in the art that the technical solutions described in the various embodiments described above can be modified or some or all of the technical features can be equivalently replaced. Any modifications or replacements do not make the essence of the corresponding technical solutions depart from the scope of the technical solutions of the embodiments of the present disclosure.

What is claimed is:

1. A terminal device comprising:
one or more processors configured to:
obtain a marker in an image captured by a photographing device;
determine position-attitude information of the photographing device relative to the marker; and
control the mobile object according to the position-attitude information of the photographing device relative to the marker.

2. The terminal device according to claim 1, wherein the position-attitude information comprises at least one of:
position information or attitude information.

3. The terminal device according to claim 1, wherein the one or more processors are further configured to determine the position-attitude information of the photographing device relative to the marker by:
determining position-attitude information of the marker in the image captured by the photographing device; and
determining the position-attitude information of the photographing device relative to the marker according to the position-attitude information of the marker in the image captured by the photographing device.

4. The terminal device according to claim 1, wherein the one or more processors are further configured to control the mobile object according to the position-attitude information of the photographing device relative to the marker by performing at least one of:
controlling position information of the mobile object relative to a preset origin according to the position information of the photographing device relative to the marker;
controlling attitude information of the mobile object according to the attitude information of the photographing device relative to the marker; or
controlling a moving speed of the mobile object according to the attitude information of the photographing device relative to the marker.

5. The terminal device according to claim 4, wherein the attitude information comprises at least one of:
a pitch angle, a roll angle, or a yaw angle.

6. The terminal device according to claim 5, wherein the one or more processors are further configured to control the moving speed of the mobile object according to the attitude information of the photographing device relative to the marker by:
controlling a speed at which the mobile object moves along a Y-axis of a ground coordinate system according to the pitch angle of the photographing device relative to the marker;
controlling a speed at which the mobile object moves along an X-axis of a ground coordinate system according to the roll angle of the photographing device relative to the marker; and
controlling a speed at which the mobile object moves along a Z-axis of a ground coordinate system according to the yaw angle of the photographing device relative to the marker.

7. The terminal device according to claim 5, wherein the one or more processors are further configured to control the attitude information of the mobile object according to the attitude information of the photographing device relative to the marker by:
controlling a pitch angle of the mobile object according to the pitch angle of the photographing device relative to the marker;
controlling a roll angle of the mobile object according to a roll angle of the photographing device relative to the marker; and
controlling a yaw angle of the mobile object according to a yaw angle of the photographing device relative to the marker.

8. The terminal device according to claim 4, wherein the one or more processors are further configured to control the position information of the mobile object relative to the preset origin according to the position information of the photographing device relative to the marker by:
controlling a distance of the mobile object relative to the preset origin according to a distance of the photographing device relative to the marker.

9. The terminal device according to claim 1, wherein the one or more processors are further configured to:
determine position-attitude-motion information of the photographing device relative to the marker; and
control the mobile object according to the position-attitude-motion information of the photographing device relative to the marker.

10. The terminal device according to claim 9, wherein the position-attitude-motion information comprises at least one of:
position-change information or attitude-change information.

11. The terminal device according to claim 9, wherein the one or more processors are further configured to determine the position-attitude-motion information of the photographing device relative to the marker by:
determining the position-attitude-motion information of the marker in at least two image frames captured by the photographing device; and
determining the position-attitude-motion information of the photographing device relative to the marker according to the position-attitude-motion information of the marker in the at least two image frames captured by the photographing device.

12. The terminal device according to claim 9, wherein the one or more processors are further configured to determine the position-attitude-motion information of the photographing device relative to the marker according to the position-attitude-motion information of the photographing device detected by an Inertial Measurement Unit (IMU).

13. The terminal device according to claim 9, wherein the one or more processors are further configured to determine the position-attitude-motion information of the photographing device relative to the marker according to the position-attitude-motion information of the marker in at least two image frames captured by the photographing device and the position-attitude-motion information of the photographing device detected by an Inertial Measurement Unit (IMU).

14. The terminal device according to claim 13, wherein the one or more processors are further configured to:
in response to an absolute value of a difference between the position-attitude-motion information of the photographing device determined according to the position-attitude-motion information of the marker in the at least two image frames captured by the photographing device and the position-attitude-motion information of the photographing device detected by the IMU is greater than a threshold, delete determined position-attitude-motion information of the photographing device relative to the marker.

15. The terminal device according to claim 9, wherein the one or more processors are further configured to control the mobile object according to the position-attitude-motion information of the photographing device relative to the marker by performing at least one of:
controlling position-change information of the mobile object relative to a preset origin according to the position-change information of the photographing device relative to the marker; or
controlling attitude-change-information of the mobile object relative to the preset origin according to the attitude-change information of the photographing device relative to the marker.

16. The terminal device according to claim 1, wherein the one or more processors are further configured to obtain the marker in the image captured by the photographing device by performing at least one of:
obtaining the marker in the image captured by the photographing device that is selected by a user;
obtaining the marker in the image captured by the photographing device that matches a preset reference image; or
obtain the marker in the image captured by the photographing device that is formed by a preset number of feature points.

17. The terminal device according to claim 16, wherein the one or more processors are further configured to obtain the marker in the image captured by the photographing device that is selected by the user by performing at least one of:
obtaining the marker selected by the user through drawing a box in the image captured by the photographing device; or
obtaining the marker selected by the user through clicking the image captured by the photographing device.

18. The terminal device according to claim 1, wherein the one or more processors are further configured to, before controlling the mobile object:
obtain a trigger command for triggering a movement of the mobile device, the trigger command being generated by an operation on an activation button.

19. The terminal device according to claim 1, wherein the one or more processors are further configured to, before determining the position-attitude information of the photographing device relative to the marker:
obtain an initialization command, the initialization command being configured to initialize the determined position-attitude information of the photographing device relative to the marker, the initialization command being generated by an operation on an activation button.

20. A system comprising:
an unmanned aerial vehicle (UAV) including:
a fuselage;
a power system provided at the fuselage and configured to provide a power for flight; and
an electronic governor communicatively connected to the power system and configured to control a flight of the UAV; and
a terminal device including:
one or more processors configured to:
obtain a marker in an image captured by a photographing device carried by the UAV;
determine position-attitude information of the photographing device relative to the marker, and
control the UAV according to the position-attitude information of the photographing device relative to the marker.
